(19) United States
(12) Patent Application Publication
(10) Pub. No.: US 2025/0322201 A1
(43) Pub. Date: Oct. 16, 2025

(54) PREDICTING RESOURCE-RELATED VALUES USING MULTI-DIMENSIONAL MACHINE LEARNING-BASED TECHNIQUES

(71) Applicant: Dell Products L.P., Round Rock, TX (US)

(72) Inventors: Bijan Kumar Mohanty, Austin, TX (US); Manoj Nambirajan, Hyderabad, Telangana (IN); Mohit Kumar Agarwal, Cyberjaya (MY); Hung T. Dinh, Austin, TX (US)

(21) Appl. No.: 18/634,251

(22) Filed: Apr. 12, 2024

(51) Int. Cl. G06N 3/04; G06N 3/084

(52) U.S. Cl. CPC G06N 3/04; G06N 3/084

(57) ABSTRACT

Methods, apparatus, and processor-readable storage media for predicting resource-related values using multi-dimensional machine learning-based techniques are provided herein. An example computer-implemented method includes obtaining data pertaining to at least one resource-related activity involving at least one resource; predicting one or more values associated with the at least one resource by processing at least a portion of the obtained data using one or more machine learning techniques; predicting one or more values attributed to the at least one resource-related activity by processing the at least a portion of the obtained data using the one or more machine learning techniques; and performing one or more automated actions based at least in part on at least a portion of the one or more predicted values associated with the at least one resource and at least a portion of the one or more predicted values attributed to the at least one resource-related activity.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

In many contexts, enterprises and/or other organizations face multiple variables which can affect outcomes for resource-related processes, particularly with respect to one or more resource-related values during such processes. However, conventional resource management techniques typically fail to determine accurate resource-related values at various portions of such processes, which can often lead to negative outcomes resulting in losses and inefficiencies with respect to time and other resources.

### SUMMARY

Illustrative embodiments of the disclosure provide techniques for predicting resource-related values using multi-dimensional machine learning-based techniques.

An exemplary computer-implemented method includes obtaining data pertaining to at least one resource-related activity involving at least one resource, and predicting one or more values associated with the at least one resource by processing at least a portion of the obtained data using one or more machine learning techniques. The method also includes predicting one or more values attributed to the at least one resource-related activity by processing the at least a portion of the obtained data using the one or more machine learning techniques. Further, the method additionally includes performing one or more automated actions based at least in part on at least a portion of the one or more predicted values associated with the at least one resource and at least a portion of the one or more predicted values attributed to the at least one resource-related activity.

Illustrative embodiments can provide significant advantages relative to conventional resource management techniques. For example, problems associated with losses and inefficiencies with respect to time and other resources are overcome in one or more embodiments through automatically predicting values for individual resources as well as values for activities involving the one or more individual resources using machine learning techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for predicting resource-related values using multi-dimensional machine learning-based techniques in an illustrative embodiment.

FIG. 2 shows example system architecture in an illustrative embodiment.

FIG. 3 shows example system architecture for a prediction engine in an illustrative embodiment.

FIG. 4 shows an example architecture of a neural network in an illustrative embodiment.

FIG. 5 shows example pseudocode for implementing data preprocessing techniques in an illustrative embodiment.

FIG. 6 shows example pseudocode for data filtering in an illustrative embodiment.

FIG. 7 shows example pseudocode for data removal in an illustrative embodiment.

FIG. 8 shows example pseudocode for deleting redundant data features in an illustrative embodiment.

FIG. 9 shows example pseudocode for encoding categorical values into numerical values in an illustrative embodiment.

FIG. 10 shows example pseudocode for splitting a dataset into training and testing subsets in an illustrative embodiment.

FIG. 11 shows example pseudocode for implementing data scaling techniques in an illustrative embodiment.

FIG. 12 shows example pseudocode for creating a neural network model in an illustrative embodiment.

FIG. 13 shows example pseudocode for neural network model training and execution in an illustrative embodiment.

FIG. 14 is a flow diagram of a process for predicting resource-related values using multi-dimensional machine learning-based techniques in an illustrative embodiment.

FIGS. 15 and 16 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

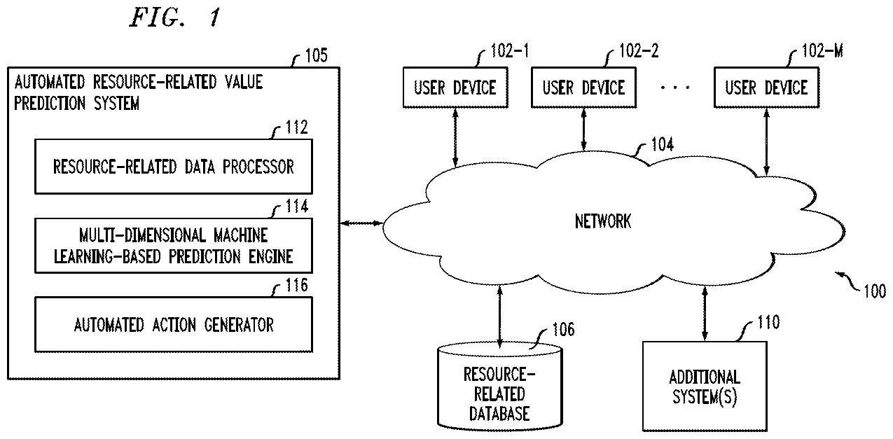

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated resource-related value prediction system 105 and one or more additional systems 110 (e.g., one or more services systems, one or more fulfillment systems, one or more sales and/or marketing systems, one or more quote and order management system, etc.).

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated resource-related value prediction system 105 can have an associated resource-related database 106 configured to store data pertaining to historical resource-related value data associated with various resource-related activities, historical total value data attributed to various resource-related activities, user data associated with various resource-related activities and/or resources, etc.

The resource-related database 106 in the present embodiment is implemented using one or more storage systems associated with the automated resource-related value prediction system 105. Such storage systems can comprise any of a variety of different types of storage including network-attached storage (NAS), storage area networks (SANS), direct-attached storage (DAS) and distributed DAS, as well as combinations of these and other storage types, including software-defined storage.

Also associated with the automated resource-related value prediction system 105 are one or more input-output devices, which illustratively comprise keyboards, displays or other types of input-output devices in any combination. Such input-output devices can be used, for example, to support one or more user interfaces to the automated resource-related value prediction system 105, as well as to support communication between the automated resource-related value prediction system 105 and other related systems and devices not explicitly shown.

Additionally, the automated resource-related value prediction system 105 in the FIG. 1 embodiment is assumed to be implemented using at least one processing device. Each such processing device generally comprises at least one processor and an associated memory, and implements one or more functional modules for controlling certain features of the automated resource-related value prediction system 105.

More particularly, the automated resource-related value prediction system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated resource-related value prediction system 105 to communicate over the network 104 with the user devices 102, and illustratively comprises one or more conventional transceivers.

The automated resource-related value prediction system 105 further comprises resource-related data processor 112, multi-dimensional machine learning-based prediction engine 114, and automated action generator 116.

It is to be appreciated that this particular arrangement of elements 112, 114 and 116 illustrated in the automated resource-related value prediction system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for predicting resource-related values using multi-dimensional machine learning techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated resource-related value prediction system 105, resource-related database 106, and additional system(s) 110 can be on and/or part of the same processing platform.

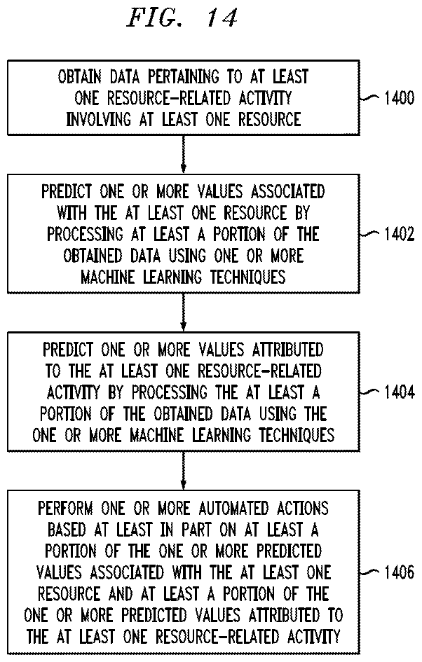

An exemplary process utilizing elements 112, 114 and 116 of an example automated resource-related value prediction system 105 in computer network 100 will be described in more detail with reference to the flow diagram of FIG. 14.

Accordingly, at least one embodiment includes predicting resource-related values using multi-dimensional machine learning techniques. As detailed herein, such an embodiment includes predicting one or more resource-related values at one or more moments during at least one resource-related activity (e.g., the unit price of a product at the beginning of a transactional opportunity lifecycle to reduce and/or minimize sales pipeline discrepancies). Such an embodiment includes leveraging one or more machine learning models trained on multi-dimensional resource-related information such as, for example, data pertaining to historical resource-related processes (e.g., historical sales data with respect to resource information, quantity data, user details, resource value (e.g., price), etc.). Predicting resource-related values using such a machine learning model can facilitate and/or initiate one or more corrective actions in connection with a corresponding resource-related activity.

By way merely of example, one or more embodiments can include predicting the unit resource (e.g., a particular product) price of a given resource associated with a corresponding resource-related activity (e.g., a transactional opportunity involving the resource) by leveraging at least one machine learning algorithm as a regressor which is trained using multi-dimensional, historical data (e.g., data pertaining to historical transactional opportunities that were successfully converted into a quote and an order). In accordance with such an example use case, as successful transactional opportunities get converted into quotes, the unit product price is commonly updated with pricing information from pricing guidance. While this may occur towards the end of a lifecycle for the given transactional opportunity, such actions can be a useful predictor for future transactional opportunities. Additionally, such a capability, enabled via use of one or more machine learning techniques, to develop pricing insights from previous transactional opportunities and applying such insights to new transactional opportunities at the beginning stages of the opportunity lifecycle can, for example, reduce and/or eliminate pipeline discrepancies, as well as improve resource capture and/or utilization.

As further detailed herein, at least one embodiment includes implementing at least one machine learning-based prediction engine that provides resource-value estimation and/or insights (e.g., resource price estimations and/or insights) for one or more users and/or related automated systems for use in connection with one or more resource-related activities (e.g., a transactional opportunity, involving a corresponding resource, during an early lifecycle stage such as a pre-proposal stage). In such an embodiment, input features for training a regression-based machine learning model can include historical resource-related activity information including, e.g., the account and/or activity name, the type of activity, the owner and/or division of an enterprise associated with the activity, resources included in the activity, resource quantities involved in the activity, etc. By way merely of example, at least one target label for such a machine learning model can include the unit resource price and/or the total price of the resource-related activity.

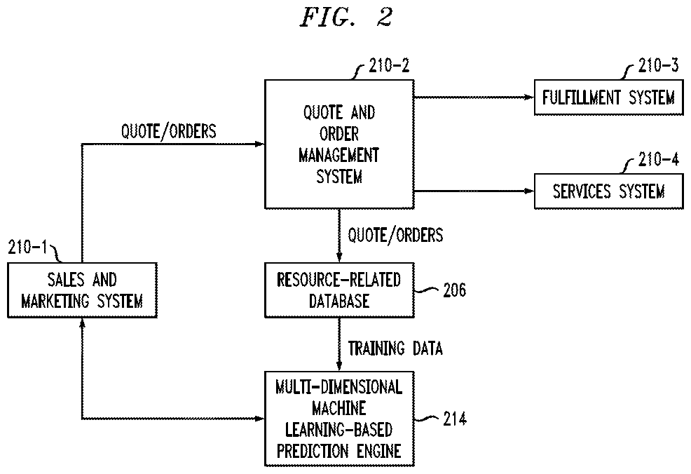

FIG. 2 shows example system architecture in an illustrative embodiment. By way of illustration, FIG. 2 depicts a sales and marketing system 210-1, which provides quote and/or order data to multi-dimensional machine learning-based prediction engine 214, which is trained using data from resource-related database 206, which includes historical quote-related and/or order-related data provided by quote and order management system 210-2. Based at least in part on the input provided by sales and marketing system 210-1, multi-dimensional machine learning-based prediction engine 214 generates a prediction regarding at least one resource value associated with the given quote and/or order and a prediction regarding at least one value attributed to the entire quote and/or order. Such predictions are then provided back to the sales and marketing system 210-1, which provides at least a portion of the predictions, along with original quote and/or order data, to quote and order management system 210-2. Based at least in part on those provided inputs, quote and order management system 210-2 generates outputs and/or instructions for fulfillment system 210-3 and services system 210-4 to facilitate execution of the quote and/or order, in accordance with the noted predictions.

Accordingly, and as further detailed herein, one or more embodiments include implementing at least one resource-related database, and at least one multi-dimensional machine learning-based prediction engine.

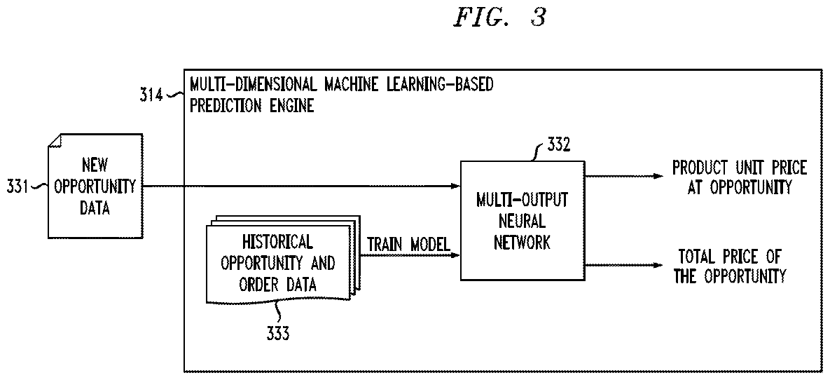

With respect to the at least one resource-related database, one or more embodiments include building and/or maintaining such a data repository to contain historical resource-related value data (e.g., product price data) across at least one enterprise. Data engineering and/or data analysis techniques can be carried out in connection with at least a portion of relevant historical data to, for example, learn and/or understand one or more features and/or one or more data elements that can influence one or more target values (e.g., resource unit price, total price of the corresponding resource-related activity) such that only those data features and/or data elements are filtered for storage in the repository. Accordingly, in such an embodiment, the at least one resource-related database can store and/or contain data pertaining to relevant data features and/or data elements including, e.g., date information, user information, resource (e.g., product) information, resource quantity information, activity type, resource value type (e.g., currency), etc. FIG. 3 shows example system architecture for a prediction engine in an illustrative embodiment. By way of illustration, FIG. 3 depicts architecture of an example multi-dimensional machine learning-based prediction engine 314, which includes at least one multi-output neural network 332 (e.g., one or more artificial neural network-based (ANN-based) multi-output regression models), which is trained using historical opportunity and order data 333. As also depicted in FIG. 3, new opportunity data 331 can be provided to and/or proceed by the multi-output neural network 332, which generates a prediction as to at least one product unit price associated with the new opportunity, and a prediction as to the total price of the new opportunity.

Accordingly, with respect to the multi-dimensional machine learning-based prediction engine 314, one or more embodiments include utilizing such a machine learning-based engine to predict and/or estimate one or more resource-related values associated with a given resource-related activity, and/or to predict and/or estimate the total value of the given resource-related activity.

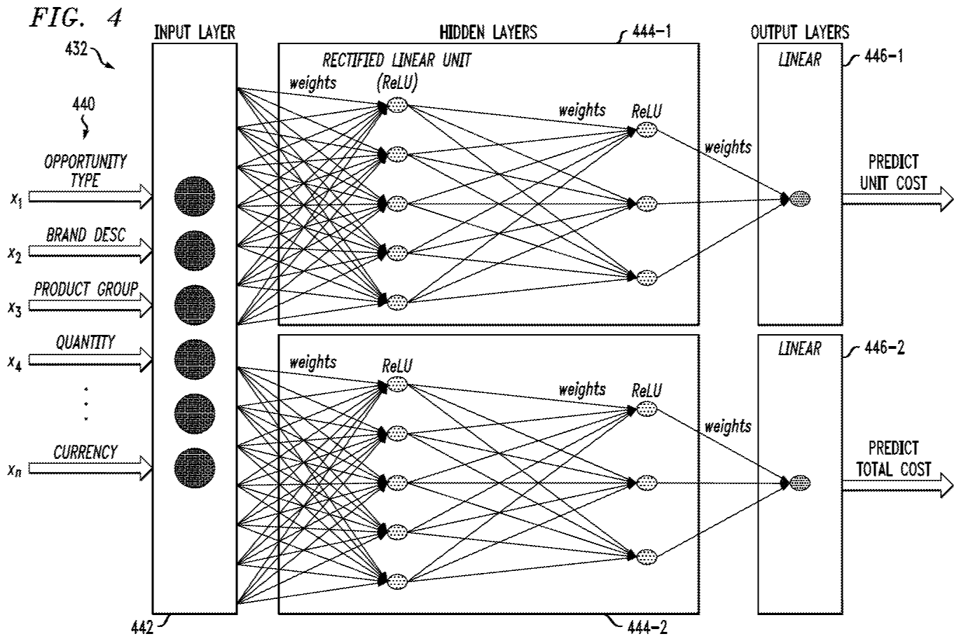

FIG. 4 shows an example architecture of a neural network in an illustrative embodiment. By way of illustration, FIG. 4 depicts a multi-output neural network 432, a type of deep neural network model that has two parallel branches of a network for two types of outputs. Accordingly, such an embodiment includes taking the same set of input variables 440 (e.g., opportunity type, brand description, product group, quantity, currency, etc.) as a single input layer 442, and building and/or training a dense, multi-layer neural network model which acts as two sophisticated classifiers for multi-output predictions. The example multi-output neural network 432 depicted in FIG. 4 includes one input layer 442, hidden layers 444-1 and 444-2, and output layers 446-1 and 446-2.

As a multi-output neural network model, the multi-output neural network 432 creates two separate branches of the network (e.g., two hidden layers, 444-1 and 444-2, as well as two output layers, 446-1 and 446-2) that connect to the same input layer 442. In at least one embodiment, such an input layer 442 can include a number of neurons that matches the number of input and/or independent variables. Also, in such an embodiment, the two hidden layers, 444-1 and 444-2, can include neurons on each layer in amounts/numbers that depend upon the number of neurons in the input layer 442. Further, in such an embodiment, the two output layers, 446-1 and 446-2 (e.g., one output layer for each branch of the model), can each contain a single neuron related to the type of output generated.

Additionally, in one or more embodiments, the at least one resource-related value prediction engine leverages at least one supervised learning mechanism and trains the corresponding model with historical data containing actual resource values for each of one or more related users (i.e., related to one or more users involved in a given resource-related activity), as well as data pertaining to the type of resource, the type of activity, the resource quantities involved in the activity, resource value denomination type (e.g., currency), location data, etc. As noted above and further detailed herein, during the training of such a machine learning model, such data features are fed into the model as the independent variable(s), and the actual resource value unit and/or the total value of the resource-related activity are utilized as the dependent and/or target variable(s).

Also, in at least one embodiment, the at least one resource-related value prediction engine utilizes at least one deep neural network by building and/or configuring a dense, multi-layer neural network model which acts as a sophisticated regressor. Such a neural network model can include at least one input layer, one or more hidden layers (e.g., two hidden layers), and at least one output layer. In one or more embodiments, the input layer includes a number of neurons that matches the number of input and/or independent variables, and the hidden layer(s) include two hidden layers, and the number of neurons on each of the two hidden layers depends on the number of neurons in the input layer. Additionally, in such an embodiment, the output layer contains a single neuron, as this neural network is a regression model, meaning that the output is a continuous, numerical value representing a given resource-related value price and/or the total price of a given resource-related activity.

By way merely of illustration, consider an example neural network model which includes five neurons in a first hidden layer and three neurons in a second hidden layer. That said, it should be appreciated, as noted above, that the actual number(s) of neurons in the hidden layer(s) can depend on the total number of neurons in the input layer. By way of further example, in one or more embodiments, the number of neurons in the first hidden layer can be calculated based on an algorithm of matching the power of two to the number of input layer neurons. For example, if the number of input variables is 19, it falls in the range of 25. That means that the first hidden layer will have 25=32 neurons, and the second hidden layer will contain 24=16 neurons. If there were to be a third hidden layer, that hidden layer would include 23=8 neurons. Also, in at least one embodiment, the neurons in the hidden layer(s) and the output layer contain at least one activation function which helps determining whether a given neuron will fire or not. In such an example embodiment (and as depicted in example multi-output neural network 432 illustrated in FIG. 4), the rectified linear unit (ReLU) activation function can be used in both hidden layers, and, as the neural network model described in this example is configured as a multi-class regression model (also referred to herein as a regressor), the output layer neurons will contain a linear activation function or no activation functions.

As one or more embodiments include using a dense neural network model (e.g., such as depicted in example multi-output neural network 432 illustrated in FIG. 4), in such an embodiment, each neuron will connect with each other neuron. Further, each connection will have a weight factor, and the neurons will have a bias factor, wherein these weight and bias values can be set randomly by the neural network model (e.g., such values can be set as 1 or 0 for all values). Also, in such an embodiment, each neuron performs a linear calculation by combining the multiplication of each input variable with their corresponding weight factors, and then adding the bias value of the neuron. The formula for this calculation is illustrated as follows:

$$ws 1 = x 1 \cdot w 1 + x 2 \cdot w 2 + … + b 1$$

wherein ws1 represents the weighted sum of neuron1, x1, x2, etc. represent the input variables to the neural network model, w1, w2, etc. represent the weight values applied to the connections to neuron1, and b1 represents the bias value of neuron1. This weighted sum is then input to an activation function (e.g., ReLU) to compute the value of the activation function. Similarly, weighted sum and activation function values of all other neurons in the layer are calculated, and these values are fed to the neuron(s) of the next layer. In at least one embodiment, the same process is then repeated in the next layer of neurons until the values are fed to the neuron of the output layer, wherein the weighted sum is also calculated and compared to the actual target value. Depending upon the difference, a loss value and/or error value can be calculated.

Such a pass through of the neural network model is referred to as a forward propagation, which calculates the loss value and/or error value and drives a backpropagation through the neural network model to reduce and/or minimize the loss value and/or error value at each neuron of the network. Considering that the loss value and/or error value is generated by all neurons in the network, backpropagation goes through each layer, from back to front, and attempts to reduce and/or minimize the loss value and/or error value by using at least one gradient descent-based optimization mechanism. Considering that, in one or more embodiments, a multi-output neural network model is used as a regressor and classifier, such an embodiment can include using the loss function of “mean_squared_error” for the both regressor branches, and using the adaptive moment estimation (Adam) function as the optimization algorithm for both branches.

In at least one embodiment, the result of a backpropagation such as detailed above is to adjust the weight and bias values at each connection and neuron to reduce the loss value and/or error value. Additionally, in accordance with one or more embodiments, once all observations of the training data are passed through the neural network model, an epoch is completed. Another forward propagation is then initiated with the adjusted weight and bias values, which is considered as epoch2, and the same process of forward and backpropagation is repeated in one or more subsequent epochs. This process of iterating multiple epochs results in the reduction of loss values and/or error values to a small number (e.g., close to zero), at which point, the neural network model is considered to be sufficiently trained for prediction.

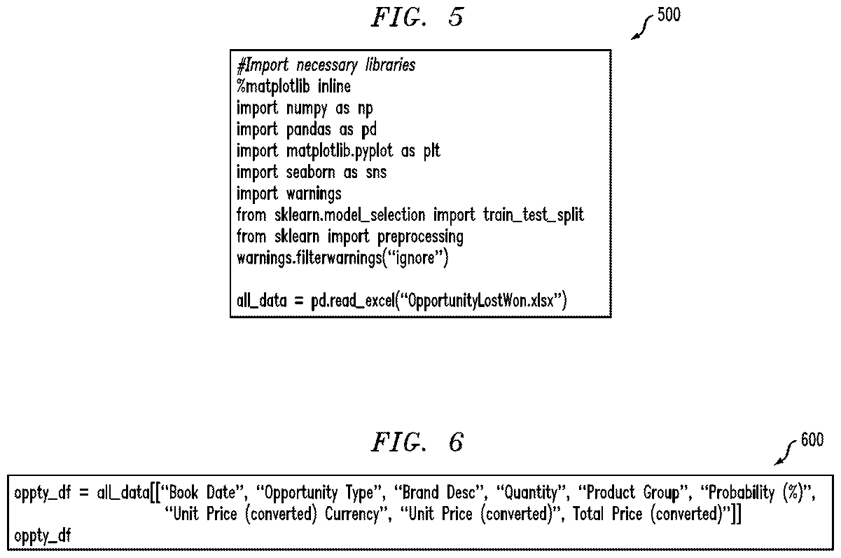

The implementation of at least portions of one or more embodiments can be achieved, for example, as depicted in FIG. 5 through FIG. 13, by using Keras with a Tensorflow backend, Python language, as well as Pandas, Numpy and ScikitLearn libraries.

FIG. 5 shows example pseudocode for implementing data preprocessing techniques in an illustrative embodiment. In this embodiment, example pseudocode 500 is executed by or under the control of at least one processing system and/or device. For example, the example pseudocode 500 may be viewed as comprising a portion of a software implementation of at least part of automated resource-related value prediction system 105 of the FIG. 1 embodiment.

The example pseudocode 500 illustrates importing necessary libraries, reading a dataset of historical opportunity outcomes, and generating a Pandas data frame. The data frame contains columns including independent variables, as well as the dependent and/or target variable columns (e.g., resource value unit and/or total value of the resource-related activity). Additionally, in connection with example pseudocode 500, preprocessing of such data includes handling any null or missing values in the columns. In one or more embodiments, null or missing values in numerical columns can be replaced by the median value of that column. After handling null or missing values in the columns, such an embodiment can include performing initial data analysis by creating one or more univariate and/or bivariate plots of the columns, whereby the importance and/or influence of each column can be understood. Columns that have limited importance and/or influence (e.g., no importance and/or influence) on the actual prediction (i.e., the dependent and/or target variable) can be removed.

It is to be appreciated that this particular example pseudocode shows just one example implementation of data preprocessing techniques, and alternative implementations can be used in other embodiments.

FIG. 6 shows example pseudocode for data filtering in an illustrative embodiment. In this embodiment, example pseudocode 600 is executed by or under the control of at least one processing system and/or device. For example, the example pseudocode 600 may be viewed as comprising a portion of a software implementation of at least part of automated resource-related value prediction system 105 of the FIG. 1 embodiment.

The example pseudocode 600 illustrates filtering out certain data, from larger opportunity datasets, which will be used for data visualization and data engineering and/or feature engineering. Opportunity data often contains a lot of information that is not related and/or relevant to the predictions detailed herein in connection with one or more embodiments. Accordingly, such an embodiment includes filtering out only the features that are pertinent and the target labels (e.g., resource value unit and/or total value of the resource-related activity) from the opportunity data, and using such filtered data for data visualization and data engineering and/or feature engineering.

It is to be appreciated that this particular example pseudocode shows just one example implementation of data filtering techniques, and alternative implementations can be used in other embodiments.

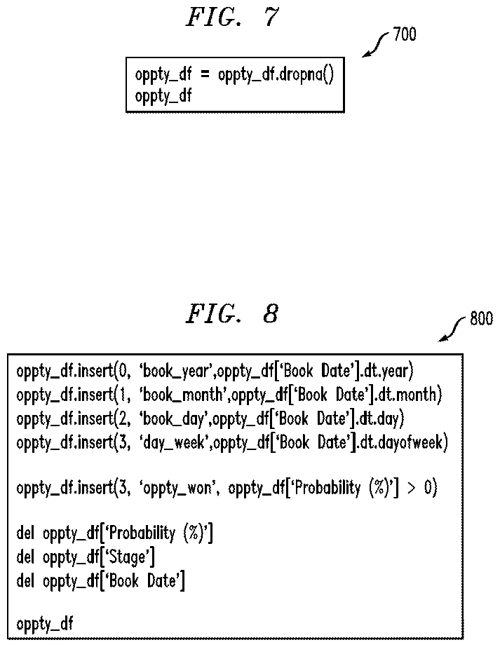

FIG. 7 shows example pseudocode for data removal in an illustrative embodiment. In this embodiment, example pseudocode 700 is executed by or under the control of at least one processing system and/or device. For example, the example pseudocode 700 may be viewed as comprising a portion of a software implementation of at least part of automated resource-related value prediction system 105 of the FIG. 1 embodiment.

The example pseudocode 700 illustrates removing observations containing incomplete data with 0 or not a number (NaN) values in one or more columns.

It is to be appreciated that this particular example pseudocode shows just one example implementation of data removal techniques, and alternative implementations can be used in other embodiments.

FIG. 8 shows example pseudocode for deleting redundant data features in an illustrative embodiment. In this embodiment, example pseudocode 800 is executed by or under the control of at least one processing system and/or device. For example, the example pseudocode 800 may be viewed as comprising a portion of a software implementation of at least part of automated resource-related value prediction system 105 of the FIG. 1 embodiment.

The example pseudocode 800 illustrates an example data object of book date, which is a dateTime object. In at least one embodiment, it is important to extract features of book year, month, date and day one or more datasets, as well as deleting one or more redundant features from the one or more datasets, as depicted via example pseudocode 800.

It is to be appreciated that this particular example pseudocode shows just one example implementation of deleting redundant data features, and alternative implementations can be used in other embodiments.

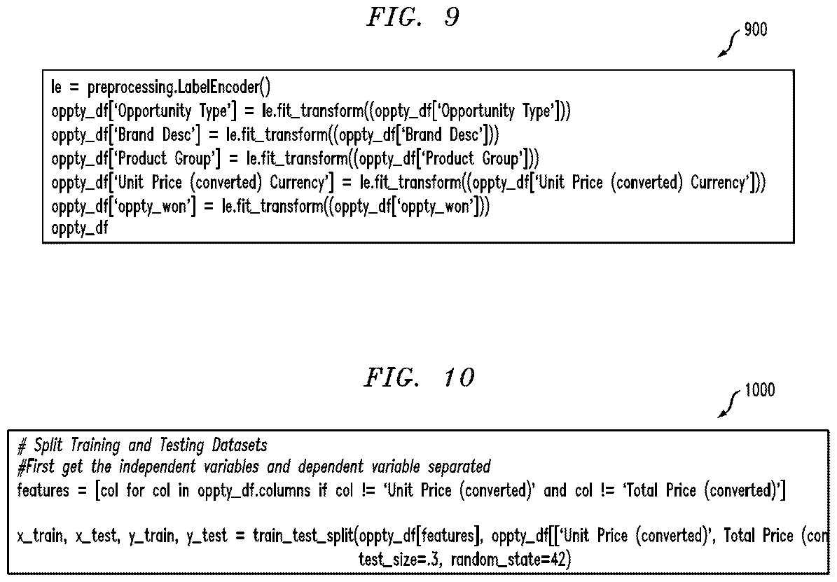

FIG. 9 shows example pseudocode for encoding categorical values into numerical values in an illustrative embodiment. In this embodiment, example pseudocode 900 is executed by or under the control of at least one processing system and/or device. For example, the example pseudocode 900 may be viewed as comprising a portion of a software implementation of at least part of automated resource-related value prediction system 105 of the FIG. 1 embodiment.

The example pseudocode 900 illustrates encoding categorical values in column data into numerical values, as machine learning models are configured to process numerical values. For example, as depicted in example pseudocode 900, categorical values such as opportunity type, brand description, product group, etc., must be encoded, and such encoding can be carried out using a LabelEncoder function from a ScikitLearn library.

It is to be appreciated that this particular example pseudocode shows just one example implementation of encoding categorical values into numerical values, and alternative implementations can be used in other embodiments.

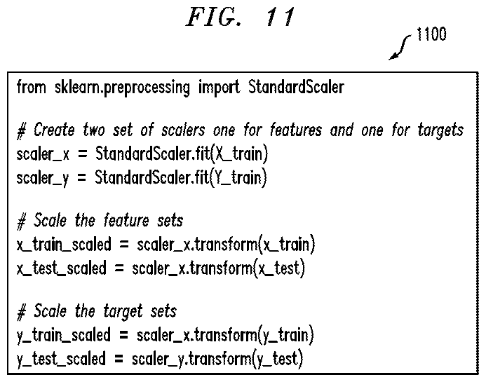

FIG. 10 shows example pseudocode for splitting a dataset into training and testing subsets in an illustrative embodiment. In this embodiment, example pseudocode 1000 is executed by or under the control of at least one processing system and/or device. For example, the example pseudocode 1000 may be viewed as comprising a portion of a software implementation of at least part of automated resource-related value prediction system 105 of the FIG. 1 embodiment.

The example pseudocode 1000 illustrates dividing or splitting a dataset into training and testing subsets using a train_test_split function from a ScikitLearn library. By way of example, such splitting can be in the form of 70% training data and 30% testing data. Because one or more embodiments encompass use cases of multi-target prediction, example pseudocode 1000 depicts separating both of the target variables from the dataset.

It is to be appreciated that this particular example pseudocode shows just one example implementation of splitting a dataset into training and testing subsets, and alternative implementations can be used in other embodiments.

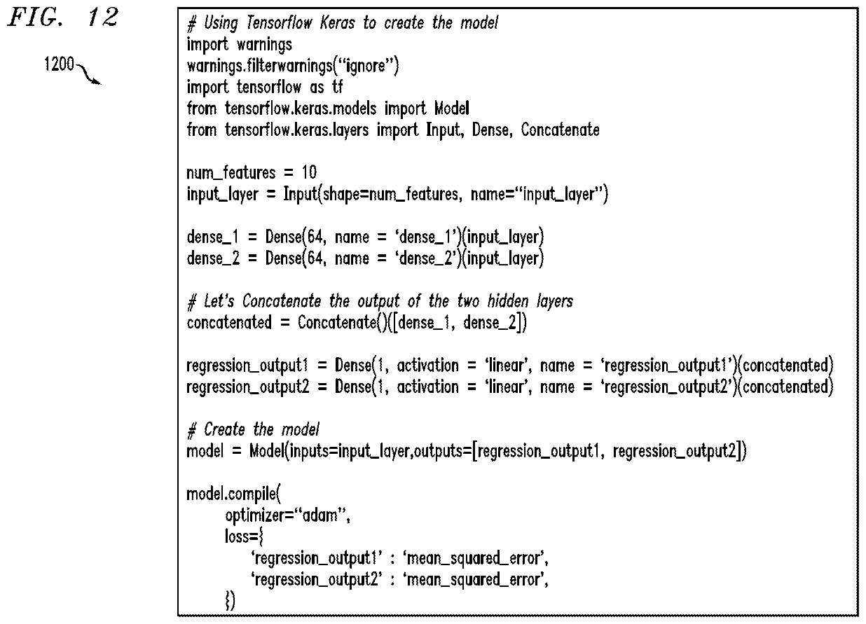

FIG. 11 shows example pseudocode for implementing data scaling techniques in an illustrative embodiment. In this embodiment, example pseudocode 1100 is executed by or under the control of at least one processing system and/or device. For example, the example pseudocode 1100 may be viewed as comprising a portion of a software implementation of at least part of automated resource-related value prediction system 105 of the FIG. 1 embodiment.

The example pseudocode 1100 illustrates normalizing and scaling the training data and testing data using a StandardScaler function from a ScikitLearn library. In one or more embodiments, after normalization, the data can be optionally passed to at least one principal component analysis (PCA) function for dimensionality reduction in preparation for model training and/or model testing.

It is to be appreciated that this particular example pseudocode shows just one example implementation of data scaling techniques, and alternative implementations can be used in other embodiments.

FIG. 12 shows example pseudocode for creating a neural network model in an illustrative embodiment. In this embodiment, example pseudocode 1200 is executed by or under the control of at least one processing system and/or device. For example, the example pseudocode 1200 may be viewed as comprising a portion of a software implementation of at least part of automated resource-related value prediction system 105 of the FIG. 1 embodiment.

The example pseudocode 1200 illustrates creating a multi-layer dense neural network using a Keras library to act as a multi-class regressor. Using the function Model( ) the functional model is created, and then individual layers of each branch are added by calling the add( ) function of the model and passing an instance of the Dense( ) function to indicate that the model is a dense neural network model. That way, all of the neurons in each layer will connect with all of the neurons from each preceding and following layer. Also, the Dense( ) function will accept parameters for the number of neurons on a given layer, the type of activation function used, and if there are any kernel parameters. Multiple hidden layers and output layers can be added by calling the same add( ) function to the model. Once the model is created, at least one loss function, at least one optimizer type, and one or more validation metrics are added to the model using compile( ) function. In at least one embodiment, mean_squared_error is used as a loss function, and the Adam function is used as an optimizer.

It is to be appreciated that this particular example pseudocode shows just one example implementation of creating a neural network model, and alternative implementations can be used in other embodiments.

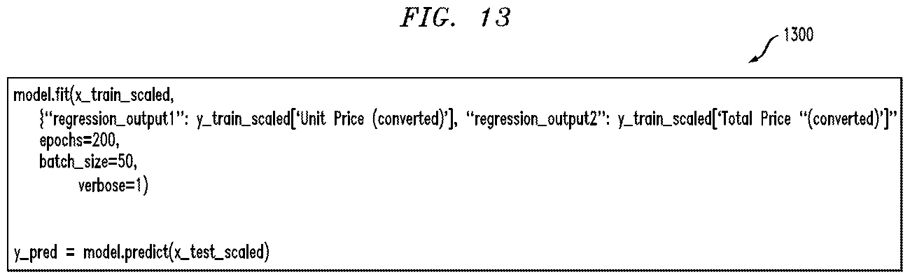

FIG. 13 shows example pseudocode for neural network model training and execution in an illustrative embodiment. In this embodiment, example pseudocode 1300 is executed by or under the control of at least one processing system and/or device. For example, the example pseudocode 1300 may be viewed as comprising a portion of a software implementation of at least part of automated resource-related value prediction system 105 of the FIG. 1 embodiment.

The example pseudocode 1300 illustrates performing neural network model training by calling the fit( ) function of the model and passing training data and a number of epochs. After the model completes the specified number of epochs, it is trained and ready for validation. The loss and/or error value can be obtained by calling the evaluate( ) function of the model, and passing testing data. This loss and/or error value indicates how well the model is trained, wherein a higher loss value means the model is not trained enough, and hyperparameter tuning is required. For example, the number of epochs can be increased to further train the model. Other hyperparameter tuning can be done, e.g., by changing the loss function, changing the optimizer algorithm, and/or making changes to the neural network architecture (e.g., by adding one or more additional hidden layers). Once the model is trained with a reasonable value of loss (e.g., as close to 0 as possible), the model is ready for prediction. Prediction of the model is achieved by calling the predict( ) function of the model, and passing the independent variables of the testing data (e.g., for comparing training and testing data) or the real values that are to be used for predicting the resource-related value(s) associated with a given resource-related activity and/or for predicting the total value of the given resource-related activity.

It is to be appreciated that this particular example pseudocode shows just one example implementation of neural network model training and execution, and alternative implementations can be used in other embodiments.

It is to be appreciated that some embodiments described herein utilize one or more artificial intelligence models. It is to be appreciated that the term “model,” as used herein, is intended to be broadly construed and may comprise, for example, a set of executable instructions for generating computer-implemented recommendations and/or predictions. For example, one or more of the models described herein may be trained to generate recommendations and/or predictions based on various forms of resource-related data and resource-related activity data, and such recommendations and/or predictions can be used to initiate one or more automated actions (e.g., automatically initiating one or more automated actions in connection with one or more additional systems in furtherance of completing the at least one resource-related activity, automatically retraining the model, etc.). By way of further example, based at least in part on historical successful resource-related activity data (e.g., winning opportunity data) that the model is trained on, one or more embodiments can include predicting multiple items such as, e.g., the unit cost of the resource (e.g., product) in question and the total cost of the entire corresponding resource-related activity (e.g., the entire commercial opportunity involving the product). Considering such predictions at one or points of the resource-related activity (e.g., at the time of sales) can then facilitate automated actions related, for example, to improve the likelihood of success of the resource-related activity (e.g., facilitating at least one automated and/or external system and/or sales agent to price the product in such a manner that the likelihood of winning the opportunity with the particular customer in question increases).

FIG. 14 is a flow diagram of a process for predicting resource-related values using multi-dimensional machine learning-based techniques in an illustrative embodiment. It is to be understood that this particular process is only an example, and additional or alternative processes can be carried out in other embodiments.

In this embodiment, the process includes steps 1400 through 1406. These steps are assumed to be performed by the automated resource-related value prediction system 105 utilizing elements 112, 114 and 116.

Step 1400 includes obtaining data pertaining to at least one resource-related activity involving at least one resource. In at least one embodiment, obtaining data pertaining to at least one resource-related activity includes obtaining one or more of historical values associated with resources related to the at least one resource, historical values attributed to previous instances of resource-related activities related to the at least one resource-related activity, data related to one or more actions already performed as part of the at least one resource-related activity, temporal data associated with the at least one resource, and user-related data associated with the at least one resource-related activity.

Step 1402 includes predicting one or more values associated with the at least one resource by processing at least a portion of the obtained data using one or more machine learning techniques. Step 1404 includes predicting one or more values attributed to the at least one resource-related activity by processing the at least a portion of the obtained data using the one or more machine learning techniques. In one or more embodiments, predicting one or more values associated with the at least one resource includes processing at least a portion of the obtained data using at least one artificial neural network-based multi-output regression model. In such an embodiment, predicting one or more values attributed to the at least one resource-related activity can include processing the at least a portion of the obtained data using the at least one artificial neural network-based multi-output regression model.

Additionally, in at least one embodiment, using the at least one artificial neural network-based multi-output regression model can include configuring the at least one artificial neural network-based multi-output regression model to include an input layer, two or more hidden layers, and two or more output layers. In such an embodiment, configuring the at least one artificial neural network-based multi-output regression model can include configuring the input layer to include a number of neurons that matches a number of input data variables, configuring the two or more hidden layers to include a number of neurons that is based at least in part on the number of neurons in the input layer, and configuring each of the two or more output layers to include a single neuron. Further, in such an embodiment, a first one of the two or more output layers can be configured to generate a prediction of the one or more values associated with the at least one resource, and a second one of the two or more output layers can be configured to generate a prediction of the one or more values attributed to the at least one resource-related activity.

Step 1406 includes performing one or more automated actions based at least in part on at least a portion of the one or more predicted values associated with the at least one resource and at least a portion of the one or more predicted values attributed to the at least one resource-related activity. In one or more embodiments, the at least one resource-related activity is ongoing, and performing one or more automated actions can include automatically initiating one or more automated actions in connection with one or more additional systems in furtherance of completing the at least one resource-related activity. Additionally or alternatively, performing one or more automated actions can include automatically training at least a portion of the one or more machine learning techniques using feedback related to one or more of the one or more predicted values associated with the at least one resource and the one or more predicted values attributed to the at least one resource-related activity.

Accordingly, the particular processing operations and other functionality described in conjunction with the flow diagram of FIG. 14 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically predict values for individual resources as well as values for activities involving the one or more individual resources using machine learning techniques. These and other embodiments can effectively overcome problems associated with losses and inefficiencies with respect to time and other resources.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

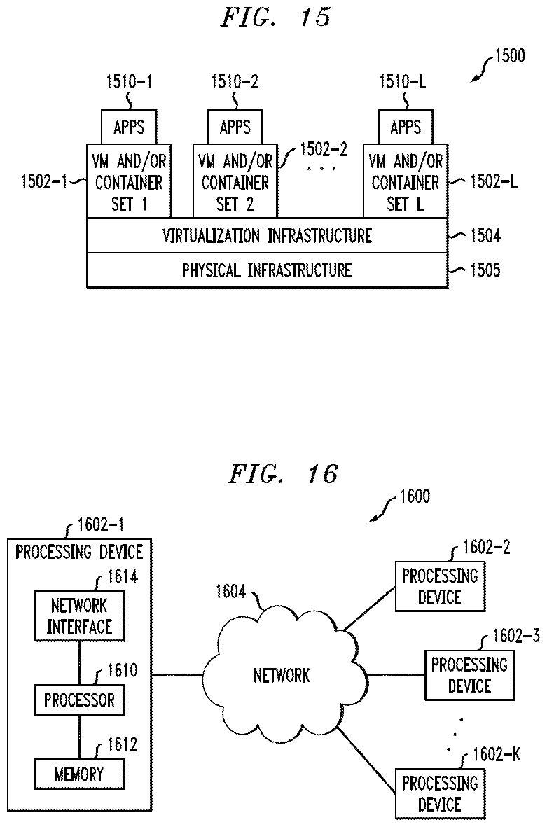

Illustrative embodiments of processing platforms will now be described in greater detail with reference to FIGS. 15 and 16. Although described in the context of system 100, these platforms may also be used to implement at least portions of other information processing systems in other embodiments.

FIG. 15 shows an example processing platform comprising cloud infrastructure 1500. The cloud infrastructure 1500 comprises a combination of physical and virtual processing resources that are utilized to implement at least a portion of the information processing system 100. The cloud infrastructure 1500 comprises multiple virtual machines (VMs) and/or container sets 1502-1, 1502-2, . . . 1502-L implemented using virtualization infrastructure 1504. The virtualization infrastructure 1504 runs on physical infrastructure 1505, and illustratively comprises one or more hypervisors and/or operating system level virtualization infrastructure. The operating system level virtualization infrastructure illustratively comprises kernel control groups of a Linux operating system or other type of operating system.

The cloud infrastructure 1500 further comprises sets of applications 1510-1, 1510-2, . . . 1510-L running on respective ones of the VMs/container sets 1502-1, 1502-2, . . . 1502-L under the control of the virtualization infrastructure 1504. The VMs/container sets 1502 comprise respective VMs, respective sets of one or more containers, or respective sets of one or more containers running in VMs. In some implementations of the FIG. 15 embodiment, the VMs/container sets 1502 comprise respective VMs implemented using virtualization infrastructure 1504 that comprises at least one hypervisor.

A hypervisor platform may be used to implement a hypervisor within the virtualization infrastructure 1504, wherein the hypervisor platform has an associated virtual infrastructure management system. The underlying physical machines comprise one or more information processing platforms that include one or more storage systems.

In other implementations of the FIG. 15 embodiment, the VMs/container sets 1502 comprise respective containers implemented using virtualization infrastructure 1504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1500 shown in FIG. 15 may represent at least a portion of one processing platform. Another example of such a processing platform is processing platform 1600 shown in FIG. 16.

The processing platform 1600 in this embodiment comprises a portion of system 100 and includes a plurality of processing devices, denoted 1602-1, 1602-2, 1602-3, . . . 1602-K, which communicate with one another over a network 1604.

The network 1604 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1602-1 in the processing platform 1600 comprises a processor 1610 coupled to a memory 1612.

The processor 1610 comprises a microprocessor, a CPU, a GPU, a TPU, a microcontroller, an ASIC, a FPGA or other type of processing circuitry, as well as portions or combinations of such circuitry elements.

The memory 1612 comprises random access memory (RAM), read-only memory (ROM) or other types of memory, in any combination. The memory 1612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1602-1 is network interface circuitry 1614, which is used to interface the processing device with the network 1604 and other system components, and may comprise conventional transceivers.

The other processing devices 1602 of the processing platform 1600 are assumed to be configured in a manner similar to that shown for processing device 1602-1 in the figure.

Again, the particular processing platform 1600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining data pertaining to at least one resource-related activity involving at least one resource;
predicting one or more values associated with the at least one resource by processing at least a portion of the obtained data using one or more machine learning techniques;
predicting one or more values attributed to the at least one resource-related activity by processing the at least a portion of the obtained data using the one or more machine learning techniques; and
performing one or more automated actions based at least in part on at least a portion of the one or more predicted values associated with the at least one resource and at least a portion of the one or more predicted values attributed to the at least one resource-related activity;
wherein the method is performed by at least one processing device comprising a processor coupled to a memory.

2. The computer-implemented method of claim 1, wherein predicting one or more values associated with the at least one resource comprises processing at least a portion of the obtained data using at least one artificial neural network-based multi-output regression model.

3. The computer-implemented method of claim 2, wherein predicting one or more values attributed to the at least one resource-related activity comprises processing the at least a portion of the obtained data using the at least one artificial neural network-based multi-output regression model.

4. The computer-implemented method of claim 2, wherein using the at least one artificial neural network-based multi-output regression model comprises configuring the at least one artificial neural network-based multi-output regression model to include an input layer, two or more hidden layers, and two or more output layers.

5. The computer-implemented method of claim 4, wherein configuring the at least one artificial neural network-based multi-output regression model comprises configuring the input layer to include a number of neurons that matches a number of input data variables, configuring the two or more hidden layers to include a number of neurons that is based at least in part on the number of neurons in the input layer, and configuring each of the two or more output layers to include a single neuron.

6. The computer-implemented method of claim 5, wherein a first one of the two or more output layers is configured to generate a prediction of the one or more values associated with the at least one resource, wherein a second one of the two or more output layers is configured to generate a prediction of the one or more values attributed to the at least one resource-related activity.

7. The computer-implemented method of claim 1, wherein the at least one resource-related activity is ongoing, and wherein performing one or more automated actions comprises automatically initiating one or more automated actions in connection with one or more additional systems in furtherance of completing the at least one resource-related activity.

8. The computer-implemented method of claim 1, wherein performing one or more automated actions comprises automatically training at least a portion of the one or more machine learning techniques using feedback related to one or more of the one or more predicted values associated with the at least one resource and the one or more predicted values attributed to the at least one resource-related activity.

9. The computer-implemented method of claim 1, wherein obtaining data pertaining to at least one resource-related activity comprises obtaining one or more of historical values associated with resources related to the at least one resource, historical values attributed to previous instances of resource-related activities related to the at least one resource-related activity, data related to one or more actions already performed as part of the at least one resource-related activity, temporal data associated with the at least one resource, and user-related data associated with the at least one resource-related activity.

10. A non-transitory processor-readable storage medium having stored therein program code of one or more software programs, wherein the program code when executed by at least one processing device causes the at least one processing device:
to obtain data pertaining to at least one resource-related activity involving at least one resource;
to predict one or more values associated with the at least one resource by processing at least a portion of the obtained data using one or more machine learning techniques;
to predict one or more values attributed to the at least one resource-related activity by processing the at least a portion of the obtained data using the one or more machine learning techniques; and
to perform one or more automated actions based at least in part on at least a portion of the one or more predicted values associated with the at least one resource and at least a portion of the one or more predicted values attributed to the at least one resource-related activity.

11. The non-transitory processor-readable storage medium of claim 10, wherein predicting one or more values associated with the at least one resource comprises processing at least a portion of the obtained data using at least one artificial neural network-based multi-output regression model.

12. The non-transitory processor-readable storage medium of claim 11, wherein predicting one or more values attributed to the at least one resource-related activity comprises processing the at least a portion of the obtained data using the at least one artificial neural network-based multi-output regression model.

13. The non-transitory processor-readable storage medium of claim 11, wherein using the at least one artificial neural network-based multi-output regression model comprises configuring the at least one artificial neural network-based multi-output regression model to include an input layer, two or more hidden layers, and two or more output layers.

14. The non-transitory processor-readable storage medium of claim 10, wherein the at least one resource-related activity is ongoing, and wherein performing one or more automated actions comprises automatically initiating one or more automated actions in connection with one or more additional systems in furtherance of completing the at least one resource-related activity.

15. The non-transitory processor-readable storage medium of claim 10, wherein performing one or more automated actions comprises automatically training at least a portion of the one or more machine learning techniques using feedback related to one or more of the one or more predicted values associated with the at least one resource and the one or more predicted values attributed to the at least one resource-related activity.

16. An apparatus comprising:
at least one processing device comprising a processor coupled to a memory;
the at least one processing device being configured:
to obtain data pertaining to at least one resource-related activity involving at least one resource;
to predict one or more values associated with the at least one resource by processing at least a portion of the obtained data using one or more machine learning techniques;
to predict one or more values attributed to the at least one resource-related activity by processing the at least a portion of the obtained data using the one or more machine learning techniques; and
to perform one or more automated actions based at least in part on at least a portion of the one or more predicted values associated with the at least one resource and at least a portion of the one or more predicted values attributed to the at least one resource-related activity.

17. The apparatus of claim 16, wherein predicting one or more values associated with the at least one resource comprises processing at least a portion of the obtained data using at least one artificial neural network-based multi-output regression model.

18. The apparatus of claim 17, wherein predicting one or more values attributed to the at least one resource-related activity comprises processing the at least a portion of the obtained data using the at least one artificial neural network-based multi-output regression model.

19. The apparatus of claim 16, wherein the at least one resource-related activity is ongoing, and wherein performing one or more automated actions comprises automatically initiating one or more automated actions in connection with one or more additional systems in furtherance of completing the at least one resource-related activity.

20. The apparatus of claim 16, wherein performing one or more automated actions comprises automatically training at least a portion of the one or more machine learning techniques using feedback related to one or more of the one or more predicted values associated with the at least one resource and the one or more predicted values attributed to the at least one resource-related activity.
